(19) United States
(12) Patent Application Publication
(10) Pub. No.: US 2010/0324977 A1
(43) Pub. Date: Dec. 23, 2010

(54) SYSTEMS, METHODS, AND APPARATUS FOR PROVIDING PROMOTIONAL INFORMATION TO A MOBILE ASSET

(75) Inventor: Bruce Dragt, Marietta, GA (US)

Correspondence Address: SUTHERLAND ASBILL & BRENNAN LLP, 999 PEACHTREE STREET, N.E., ATLANTA, GA, 30309, US

(73) Assignee: FIRST DATA CORPORATION, Greenwood Village, CO (US)

(21) Appl. No.: 12/487,208

(22) Filed: Jun. 18, 2009

(51) Int. Cl. G06Q 30/00; G01S 1/00; H04B 7/00

(52) U.S. Cl. 705/14.1; 705/14.55; 705/14.58; 705/14.64; 705/14.53; 705/14.73; 705/14.62; 705/14.51; 455/41.2

(57) ABSTRACT

Systems, methods, and apparatus for providing promotion information to a mobile asset are provided by various embodiments of the invention. At least one triggering event for soliciting promotional information may be detected. Based on the detection, a request for promotional information may be communicated to a promotional information server and promotional information may be received in response to the request. At least a portion of the promotional information may be presented to a user by a designated asset.

### CROSS-REFERENCE TO RELATED APPLICATIONS

This application is related to U.S. patent application Ser. No. 12/396,241 filed Mar. 2, 2009 and entitled “Systems, Methods, and Devices for Administering Consumer Rewards Programs Through the Use of Tones Sent to Mobile Devices”; U.S. patent application Ser. No. 12/396,258 filed Mar. 2, 2009 and entitled “Systems, Methods, and Apparatus for Providing Promotion Information to a Mobile Device”; U.S. patent application Ser. No. 12/396,240 filed Mar. 2, 2009 and entitled “Systems, Methods, and Apparatus for Marketing by Communicating Tones to a Mobile Device”; U.S. patent application Ser. No. 12/396,255 filed Mar. 2, 2009 and entitled “Systems, Methods, and Apparatus for Communicating Information to a Mobile Device in a Broadcast Signal”; U.S. patent application Ser. No. 12/396,261 filed Mar. 2, 2009 and entitled “Systems, Methods, and Apparatus for Facilitating Communication Between Mobile Devices”; U.S. patent application Ser. No. 12/396,248 filed Mar. 2, 2009 and entitled “Systems, Methods, and Devices for Prompting Mobile Device Users for Feedback Information Using Tone Transmissions”; U.S. patent application Ser. No. 12/396,265 filed Mar. 2, 2009 and entitled “Systems, Methods, and Apparatus for Facilitating Transactions Using a Mobile Device”; U.S. patent application Ser. No. 12/396,242 (Attorney Docket No. 34250-1315) filed Mar. 2, 2009 and entitled “Systems, Methods, and Apparatus for Providing Terms and Conditions and Program Enrollment Information to a Mobile Device”; U.S. patent application Ser. No. 12/396,256 filed Mar. 2, 2009 and entitled “Systems, Methods, and Devices for Communicating Supplemental Information to Mobile Devices”; U.S. patent application Ser. No. 12/396,268 filed Mar. 2, 2009 and entitled “Systems, Methods, and Apparatus for Receiving Information by a Mobile Device”; U.S. patent application Ser. No. 12/396,271 filed Mar. 2, 2009 and entitled “Systems, Methods, and Apparatus for Providing Information to a Mobile Device”; U.S. patent application Ser. No. 12/396,259 filed Mar. 2, 2009 and entitled “Systems, Methods, and Apparatus for Receiving Promotion Information by a Mobile Device”; and U.S. patent application Ser. No. 12/396,263 filed Mar. 2, 2009 and entitled “Systems, Methods, and Devices for Processing Feedback Information Received from Mobile Devices Responding to Tone Transmissions.” Each of these applications is incorporated by reference herein in its entirety.

### FIELD OF THE INVENTION

Embodiments of the invention relate generally to mobile assets, and more particularly, to systems, methods, and apparatus providing promotional information to a mobile asset.

### BACKGROUND OF THE INVENTION

A wide variety of promotional marketing and advertising methods and techniques are utilized to provide promotional information, such as advertisements, coupons, rebates, sale information, and/or discount offers, to a consumer. Examples of traditional promotional techniques include the use of flyers, mailings, coupon dispensers, and freestanding newspaper inserts. More modern marketing techniques, including the use of modern technologies and communication media including the use of email, the Internet, etc. Each of these examples may provide a consumer with promotional information, such as an offer to participate or enroll in a marketing program, to open an account, and the like.

However, conventional communication techniques such as advertisements, mailings, flyers, and email communications typically cannot be tailored or customized per the customer and/or validated or activated in real-time or near real-time. Instead, various conventional techniques typically can only transmit active coupons or other incentives, and cannot tailor or otherwise limit the promotion program based on an individual, based on circumstances surrounding the individual, and/or permit real-time or near-real-time responses, information, and feedback. Moreover, these various conventional techniques fall short of enticing the consumer with sufficient information, while at the same time increasing the conveniences on the consumer and decreasing the costs and efforts of the entity maintaining the marketing or other program. First, with some promotion marketing techniques, such as billboards, posters, radio advertisements, and television advertisements, the consumer is not provided with information that they can review at a later point in time. The consumer may also desire additional information for regarding the promotion that is not provided by a billboard or poster. Additionally, with conventional marketing techniques, the consumer may be provided with information that is easily misplaced or lost and, therefore, not readily accessible at a subsequent point in time. The entities offering or maintaining marketing promotions can benefit from obtaining analyzing the performance or conditions of the promotion before activating the promotion for the customer; however, doing so can be cumbersome and impractical with these conventional techniques.

### SUMMARY OF THE INVENTION

Some or all of the above needs and/or problems may be addressed by certain embodiments of the invention. Embodiments of the invention may include systems, methods, and apparatus for providing promotional information to a mobile asset. According to one embodiment, a method for soliciting promotional information by a mobile device is provided. The method may include detecting a triggering event for soliciting promotional information. Based on the detection, a request for promotional information may be communicated to a promotional information server and promotional information may be received in response to the request. At least a portion of the promotional information may be presented to a user by a designated asset.

According to another embodiment, a system for soliciting promotional information is provided. The system may include a network interface and at least one processor. The network interface may be operable to communicate a request for promotional information to a promotional information server and to receive the promotional information in response to the request. The at least one processor may be operable to detect a triggering event for soliciting promotional information and to direct the network interface to communicate the request based upon the detection. The at least one processor may further be operable to present at least a portion of the received promotional information to a user.

According to yet another embodiment, a method for presenting promotional information to a mobile asset is provided. The method may include receiving a promotional information request from a mobile asset, wherein the promotional information request is generated by the mobile asset based on the detection of a triggering event. A promotional information may be prepared based at least in part on the request received from the mobile asset. The promotional information may then be communicated to a designated asset.

Additional systems, methods, apparatus, features, and aspects are realized through the techniques of various embodiments of the invention. Other embodiments and aspects of the invention are described in detail herein and are considered a part of the claimed invention. Other advantages and features can be understood with reference to the description and to the drawings.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram of one example system that may facilitate the communication of promotional information to one or more mobile assets, according to an illustrative embodiment of the invention.

FIG. 2 is a schematic diagram of one example mobile asset that may be utilized in accordance with various embodiments of the invention.

FIG. 3 is a diagram of one example data flow of communicating a request for promotional information to a promotional information server and communicating promotional information to a mobile asset in response to the request, according to an illustrative embodiment of the invention.

FIG. 4 is a flow chart of one example method for soliciting promotional information by a mobile asset, according to an illustrative embodiment of the invention.

FIG. 5 is a flow chart of one example method for processing promotional information requests received from a mobile asset, according to an illustrative embodiment of the invention.

### DETAILED DESCRIPTION OF EMBODIMENTS OF THE INVENTION

Example embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

In accordance with embodiments of the invention, systems, methods, and apparatus for providing promotional information to a mobile asset are provided. The widespread use of mobile assets, such as cellular phones or smart phones, provides a new, very effective channel to reach potential customers to transmit information, such as marketing information like promotions, offers, coupons, discounts, and the like. Moreover, mobile assets provide a relatively simple and convenient means to request additional information and feedback from potential customers, as well as automatically monitor downstream uses tied to the promotional information transmitted to the mobile assets.

Various embodiments described herein can include providing promotional information to a mobile asset, which may be used to encourage consumer behavior and/or purchasing of goods and services. The terms “promotional information,” “promotions,” and “offers” are used interchangeably herein, and each refers to information and/or programs to encourage consumer behavior, such as, but not limited to, coupons, discounts, special offers, introductory prices, trial periods, free goods or services, or any other incentive offered to a consumer. In various examples, the promotional information may provide or be associated with redeemable promotions or instruments for redemption during a transaction, such as a purchase of a good or service. The terms “redeemable promotion” and “actual redeemable promotion” are used interchangeably herein, and each refers to an instrument that can be presented and effect the incentive provided by the promotion, including, but not limited to, a coupon, an access code, an authorization code, a barcode, a password, an image, a graphic display or depiction of a coupon, an electronic file, a printable image or depiction of coupon, or any other means for indicating the terms and/or validity of the promotion.

As used herein, the term “mobile asset” may refer to any device, system, combination of devices, and/or combination of systems that is operable to request or direct a request for promotional information to a promotional information server. The mobile asset may also be operable to receive promotional information from the promotional information server in response to a request. Examples of mobile assets include, but are not limited to, mobile devices, automobiles, motorcycles, other motor vehicles, etc.

As used herein, the term “mobile device” may refer to any mobile device that is operable to receive promotional information for presentation to a user. Mobile devices may be devices that are carried by a target user and information, such as marketing information, may be communicated to the user via the mobile devices. Examples of mobile devices include, but are not limited to, cellular phones, iPhones, smart phones, personal digital assistants (PDA's), pagers, digital audio players, handheld portable computers, digital tablets, laptop computers, etc. Additionally, for purposes of this disclosure, the terms “mobile device,” “mobile communications device,” “mobile phone,” “cellular phone,” and “cell phone” may be used interchangeably.

As used herein, the term “tone” may refer to a tone carrying information that may be communicated or output by a mobile asset. For example, promotional information communicated to a mobile asset may include one or more audio files that include one or more tones that may be output by the mobile asset. The terms “tone” and “information carrying tone” may be used interchangeably herein. A wide variety of methods and/or techniques may be utilized to facilitate the output of a tone by a mobile asset. In certain embodiments of the invention, a tone may be output by one or more suitable output devices associated with the mobile asset, for example, one or more speakers, and the tone may be received by one or more suitable input devices associated with a recipient device or system, for example, a microphone. A tone may be a wave, such as an elastic wave, a primary wave or P-wave, that is propagated between the mobile asset and the recipient. In certain embodiments of the invention, a tone may be a vibration wave that is propagated though a solid, liquid, or gas. For example, in various embodiments of the invention, a tone may be a sound wave that is emitted or otherwise output by the by the mobile asset for reception by a recipient. Tones in accordance with embodiments of the invention may have a wide variety of different frequencies and/or amplitudes as desired. For example, in some embodiments, a tone may be a sound wave that is within a range that may be detected by the human ear, for example, a sound wave with a frequency between approximately 20 hertz and approximately 20 kilohertz. In such an example embodiment of the invention, it may be desirable to have the tone be produced at a frequency range that is not detectable by the naked ear for at least a significant portion of the human population (e.g., a frequency range of 17 kilohertz-20 kilohertz). In other embodiments, a tone may be a sound wave that is outside the normal range that may be detected by the human ear, for example, a sound wave with a frequency above approximately 21 kilohertz. In these embodiments, a tone may be transmitted without being aurally detected by a user of the mobile asset or the recipient. Once received, the tone may be processed by the recipient to extract at least a portion of the information included in the tone. Information embedded in or otherwise carried by the tone can include information associated with a promotion and/or one or more location identifiers, or other unique identifiers, that facilitate the request and/or gathering of additional information associated with the tone. A tone may be output utilizing a wide variety of signals as desired in various embodiments of the invention. For example, in certain embodiments, the information carried in a tone may be added to a base or carrier signal by modulating the base signal.

Various embodiments described herein can include receiving promotional information on a mobile asset. According to one embodiment, the mobile asset may request promotional information based on the identification or detection of a suitable triggering event by the mobile asset. For example, a mobile asset, such as a mobile device, may request promotional information based upon a Bluetooth synchronization between the mobile device and a motor vehicle or based upon the detection of a predetermined movement that suggests that the user of the mobile device is traveling within a motor vehicle. Promotional information may then be communicated to the mobile asset by a promotional information server in response to the request. In certain embodiments, the promotional information may be targeted towards the user of the mobile asset. As desired, the identification of promotional information to communicate to the mobile asset may take a wide variety of other considerations into account, such as a user profile, user preferences, the location of the mobile asset, the time of day, the day of week, etc. Additionally, as desired in certain embodiments, once promotional information is received by the mobile asset, a user of the mobile asset may request and receive additional information associated with the promotional information. For example, the promotional information may include an offer for a redeemable coupon, and the user of the mobile asset may request and receive the redeemable coupon after reviewing the offer. Accordingly, interacting with a mobile asset to transmit promotional information or any other associated information, creates a beneficial channel for interacting with potential customers.

In addition, in various example embodiments, upon receiving promotional information, whether it be the initial information, or subsequently transmitted information, such as a redeemable promotion, the individual can present the received promotional information for redemption. For example, a redeemable promotion can be transmitted from a mobile device to a transaction terminal (e.g., a point of sale (“POS”) terminal at a merchant) for redemption in association with a purchase (or other transaction). In another example, the promotional information may be displayed on the display screen of a mobile asset, such that the merchant may manually or with the aid of a suitable device account for the promotion during redemption. In yet another example, the promotional information may be downloaded and/or printed, such as from a personal computer, a kiosk, a POS terminal, and the like.

Due to the integration with the individual's mobile asset, such as during initial inquiry and during redemption, certain entities, such as back-end processors, merchants, manufacturers, service providers, and the like, may be configured to obtain status updates and track the individual's activities associated with the promotions via the mobile asset. For example, individual feedback may be requested from the consumer via the mobile asset. In another example, the mobile asset may transmit messages to back-end processors or merchants (or any other entity) upon performing pre-defined activities (e.g., upon receiving promotional information, upon redeeming promotional information, etc.).

Accordingly, integrating promotional information processing and distribution with mobile asset communications not only creates a simple and cost-effective channel for accessing potential consumers and transmitting promotional information, but may also permit closer tracking of consumers' behaviors regarding the respective promotions.

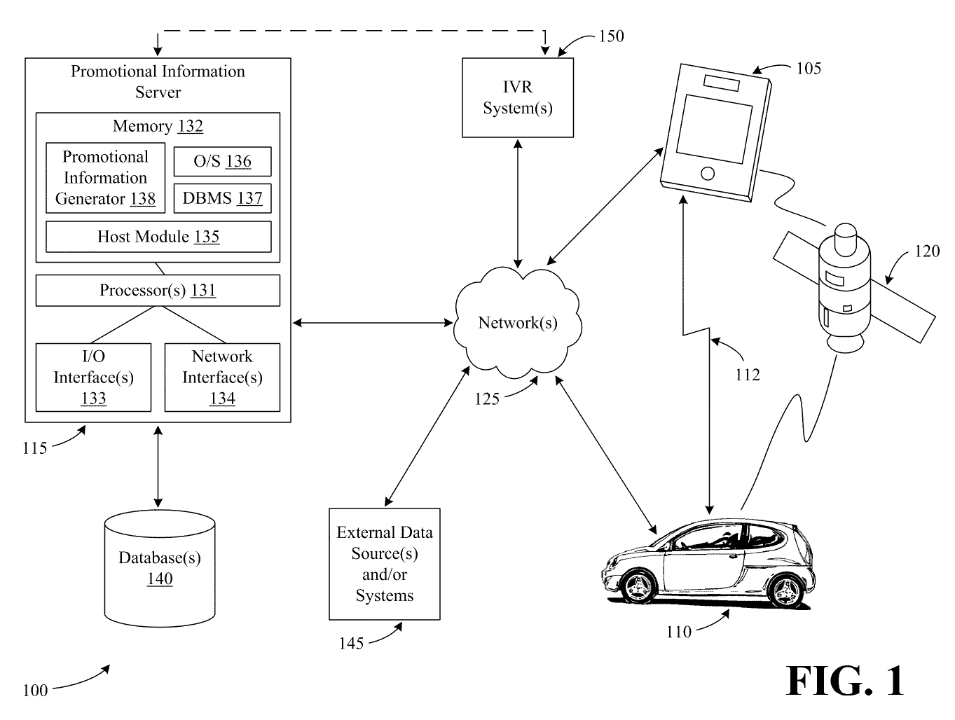

A wide variety of different systems and methods may be utilized as desired in various embodiments of the invention to receive solicitations for promotional information and/or to communicate promotional information to a mobile asset. A few example systems and methods are discussed below with reference to FIGS. 1-5.

Illustrative System Overview

FIG. 1 is a schematic diagram of one example system 100 that may facilitate the communication of promotional information to a mobile asset, according to an illustrative embodiment of the invention. The system 100 may include one or more mobile assets 105, 110, a promotional information server 115, and/or one or more global positioning system (GPS) satellites 120.

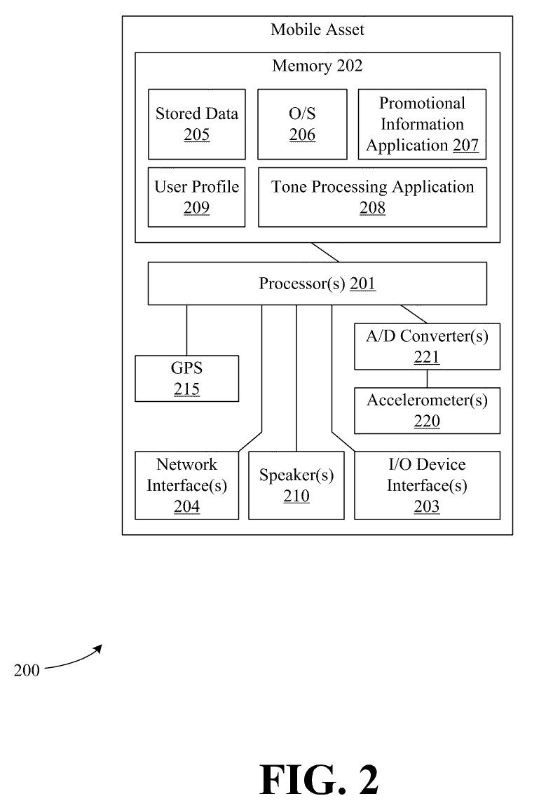

Any number of mobile assets may be utilized in as desired in various embodiments of the invention. As shown in FIG. 1, a mobile device 105 and/or a motor vehicle 110, such as an automobile, may be provided as mobile assets. Example components of a mobile asset 105, 110 are discussed in greater detail below with reference to FIG. 2. As desired, one or more of the mobile assets may be in communication with one another. For example, the mobile device 105 and the motor vehicle 110 illustrated in FIG. 1 may be in communication with one another via one or more suitable network links 112, such as a wired network connection, a wireless network connection, a Bluetooth connection, a WiFi connection, etc.

According to an aspect of the invention, at least one mobile asset 105, 110 may detect or identify a triggering event and, based upon the detection of a triggering event, request or direct the requesting of promotional information from the promotional information server 115. For example, a mobile asset, such as the mobile device 105 or the motor vehicle 110, may detect a triggering event and request promotional information from the promotional information server 115. As another example, a first mobile asset, such as the motor vehicle 110, may detect a triggering event and direct another mobile asset or device, such as the mobile device 105, to request promotional information from the promotional information server 115. A request for promotional information may be communicated to the promotional information server 115 via any number of suitable networks 125, for example, a wide area network, the Internet, a cellular network, a public switch telephone network, etc.

In certain embodiments of the invention, information associated with a location of a mobile asset 105, 110 may be included in a request for promotional information that is communicated to the promotional information server 115. Alternatively, location information may be provided to the promotional information server 115 in response to a request for the location information that is received from the server 115 at a mobile asset 105, 110. A wide variety of suitable techniques and/or methods may be utilized by a mobile asset 105, 110 to obtain or determine location information that may be communicated to the promotional information server 115. For example, a mobile asset 105, 110 may include a global positioning satellite (GPS) receiver that is in communication with one or more GPS satellites 120. The mobile asset 105, 110 may determine the location information utilizing the GPS receiver. In certain embodiments, a GPS receiver may be incorporated into a mobile asset 105, 110 that requests the promotional information. For example, a GPS receiver may be incorporated into a mobile device 105 or motor vehicle 110 that requests promotional information. In other embodiments, the requesting mobile asset 105, 110 may obtain the location information from another mobile asset 105, 110 or device. For example, a motor vehicle 110 may include a GPS receiver, and the motor vehicle may communicate location information to a mobile device 105 that requests promotional information.

The promotional information server 115 may receive a request for promotional information and communicate or direct the communication of promotional information to one or more mobile assets 105, 110 in response to receiving the request. The promotional information server 115 may identify one or more items of promotional information to communicate to a mobile asset based upon a wide variety of different factors, preferences and/or parameters. Examples of parameters utilized to identify promotional information to be communicated include, but are not limited to, the identity of a user associated with the mobile asset 105, 110, a user profile associated with the user, user preferences associated with the user, the location of the mobile asset 105, 110, a time of day, a day of week, etc. Once one or more items of promotional information are identified, the promotional information may be communicated to one or more mobile assets 105, 110. For example, the promotional information may be communicated to the requesting mobile asset. As another example, the promotional information may be communicated to another mobile asset associated with the requesting mobile asset.

A mobile asset 105, 110 may receive promotional information from the promotional information server 115 via any number of suitable networks, such as networks 125. The received promotional information may be received in a wide variety of different formats, for example, as one or more emails, as one or more short message service (SMS) or text messages, as one or more mobile browser communications, as one or more calls executed by an interactive voice response (IVR) system, automatic dialing systems, or by one or more individuals. Additionally, a wide variety of types of information may be included in the received promotional information, for example, text, images, audio files, hyperlinks and/or location identifiers, etc. As one example, text and/or images associated with a promotional offer may be included in the promotional information. The text and/or images may include a coupon that is redeemable at a merchant. In some embodiments, a barcode image associated with an offer, rebate, coupon, etc., may be included as a machine readable image that can be presented to a merchant by a mobile asset. As another example, audio files may include audible information that may be output to a user to convey promotional information. As another example, audio files may include one or more inaudible tones associated with a promotional offer, and the one or more inaudible tones may be output by a mobile asset for receipt by a merchant in order to redeem a promotional offer. As yet another example, hyperlinks and/or other location identifiers may be selected by a user to request and obtain additional promotional information from one or more data sources, such as the promotional information server 115.

Once promotional information is received by a mobile asset 105, 110, in certain embodiments, at least a portion of the promotional information may be presented to a user via any number of suitable output devices, such as displays, speakers, etc. These output devices may be associated with a designated asset. In some embodiments the designated asset may be the mobile asset 105, 110 that receives the promotional information. In other embodiments, the designated asset may be another device or system in communication with the receiving mobile asset, for example, another mobile asset. As one example, a first mobile asset, such as a mobile device 105, may receive promotional information, and at least a portion of the promotional information may be presented to a user via one or more output devices associated with another mobile asset, such as a display and/or speakers associated with a motor vehicle 110 in communication with the mobile device 105.

Additionally, as desired in various embodiments, at least a portion of the received promotional information may be stored in one or more suitable memory devices associated with one or more mobile assets 105, 110. In this regard, promotional information may be accessed at a subsequent point in time for review by a user of a mobile asset 105, 110 and/or for redemption at a merchant location.

In certain embodiments of the invention, a single mobile asset, such as the mobile device 105 or the motor vehicle 110, may be operable to communicate with the promotional information server 115. In this regard, the mobile asset may request and receive promotional information from the promotional information server 115. The communication of a request for promotional information to the promotional information server 115 may be initiated by the mobile asset detecting a triggering event. Alternatively, the communication of a request may be initiated based on the direction of another mobile asset. For example, the motor vehicle 110 may detect a triggering event and direct the mobile device 105 to request promotional information from the promotional information server 115. As another example, the mobile device 105 may detect a triggering event and direct the motor vehicle 110 to request promotional information from the promotional information server 115.

In other embodiments of the invention, two or more different channels of communication may be utilized to request and receive promotional information. For example, a first mobile asset utilizing a first channel of communication may request promotional information from the promotional information server 115, and a second mobile asset may then receive promotional information from the promotional information server 115 via a second channel of communication. The two or more channels of communication may utilize the same type of network or multiple types of networks as desired in various embodiments of the invention.

With continued reference to FIG. 1, the promotional information server 115 may be operable to receive and process requests for promotional information. The promotional information server 115 may be a processor driven device or network entity that facilitates the receipt of a request for promotional information, the identification of one or more items of promotional information to communicate to one or more mobile asset 105, 110, the accessing of the identified promotional information, and the communication of the promotional information to one or more mobile assets 105, 110 in response to the received request for the promotional information. The promotional information server 115 may include any number of processors and/or processing components as desired in various embodiments of the invention. For example, the promotional information server 115 may include any number of special purpose computers or other particular machines, application specific circuits, microcontrollers, personal computers, servers, and the like. In certain embodiments, at least a portion of the operations of the promotional information server 115 may be controlled by computer-executed or computer-implemented instructions that are executed by one or more processors associated with the promotional information server 115. The instructions may be embodied in one or more software components as desired in various embodiments of the invention. The execution of the instructions may form a special purpose computer or other particular machine that is operable to receive and process requests for promotional information. Additionally, in certain embodiments of the invention, the operations and/or control of the promotional information server 115 may be distributed amongst several processing components.

The promotional information server 115 may include one or more processors 131, one or more memory devices 132, one or more input/output (I/O) interface(s) 133, and one or more network interface(s) 134. The one or more memory devices 132 may be any suitable memory devices and/or associated data repositories, for example, caches, read only memory devices, random access memory devices, magnetic storage devices, databases, etc. The one or more memory devices 132 may store data, executable instructions, and/or various program modules utilized by the promotional information server 115, for example, a host module 135, an operating system 136, a database management system (DBMS) 137, and/or a promotional information generator 138. Additionally, one or more databases 140 may store promotional information and/or associated data, such as, preferences and/or rules for identifying relevant promotional information, various user profiles, etc. The stored promotional information may include any suitable promotional information that may be communicated to a mobile asset 105, 110. Stored preferences and/or rules for identifying relevant promotional information may include a wide variety of rules and/or preferences, including but not limited to, preferences associated with a particular user, preferences associated with various locations and/or regions, preferences associated with a time of day, preferences associated with a day of week, etc. Stored user profiles may include information associated with one or more users of mobile assets and/or promotional information preferences for the one or more users. Examples of information that may be stored in a user profile include, but are not limited to, demographic information associated with a user (e.g., age, gender, income level, address, etc.), information associated with mobile associated with the user (e.g., type of devices, capabilities of devices), a purchasing history of the user, information associated with offers that have been previously accepted by the user, user preferences as to the types of offers that the user is interested in, etc.

In certain embodiments of the invention, the promotional information server 115 may include one or more software modules, such as a host module 135, an operating system 136 and/or a promotional information generator 138. The operating system 136 may control the general operation of the promotional information server 115 and may facilitate the execution of other software modules by the one or more processors 131, for example, the execution of the host module 135, the DBMS 137, and/or the promotional information generator 133. The host module 135 or server module may include computer-executable instructions that facilitate the creation of a network session with one or more mobile assets 105, 110 in order to receive a request for promotional information and/or to communicate promotional information in response to a received request. The DBMS 137 may include computer-executable instructions that facilitate the management and/or access of one or more databases 140 associated with the promotional information server 115. The promotional information generator 138 may include computer-executable instructions that facilitate the identification, generation, and/or formatting of promotional information to communicate to one or more mobile assets 105, 110 in response to a received request. For example, the promotional information generator 138 may facilitate the identification of promotional information based upon any number of factors and/or parameters, such as, the identity of a user, preferences of the user, the location of a mobile asset, the time of day, the day of week, etc. Although the promotional information generator 138 is illustrated as a single software component, the promotional information generator 138 may include any number of software components, modules, and/or applications as desired in various embodiments of the invention.

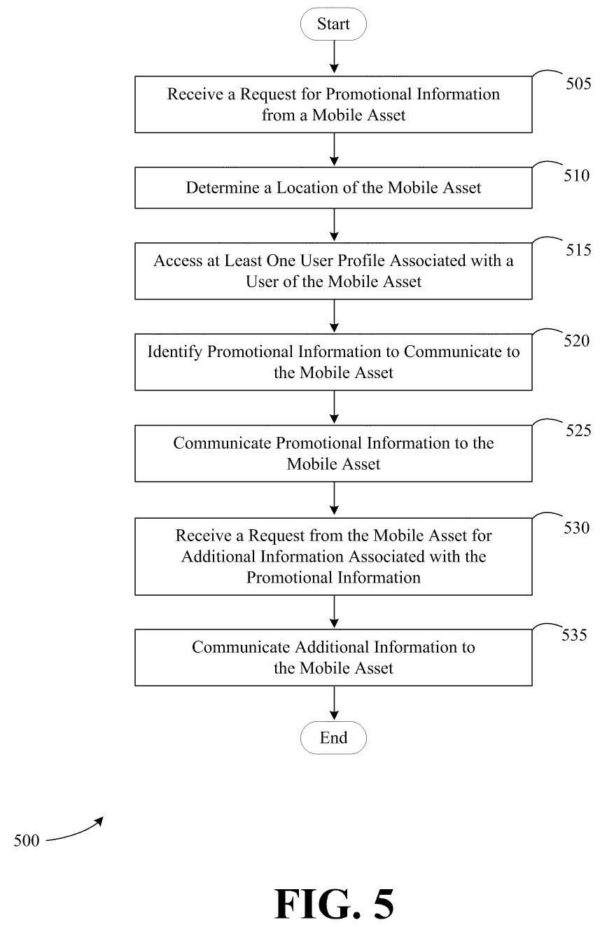

A request for promotional information may include an identifier of one or more mobile assets 105, 110, for example, a telephone number associated with a mobile asset, a universal integrated circuit card (UICC) identifier, a subscriber identity module (SIM) card identifier, an international mobile subscriber identity (IMSI) number associated with a mobile asset 200, or any other identifier that facilitates communication with an information source (e.g., a back-end processor Mobile Gateway identifier). Additionally, in certain embodiments, the request may include location information for a mobile asset, user identifying information, and/or user preferences. The promotional information generator 138 may receive the request and identify, generate, and/or format promotional information to be communicated to one or more mobile assets in response to the request. As explained in greater detail below with reference to FIG. 5, a wide variety of factors and/or preferences may be utilized to identify promotional information to be communicated by the promotional information server 115. Once one or more items of promotional information are identified, the promotional information may be accessed, obtained, and/or generated by the promotional information generator 138. For example, promotional information may be accessed from one or more databases 140 associated with the promotional information server 115. As another example, promotional information may be requested from and obtained from one or more external data sources and/or systems 145 via any number of suitable networks, such as a local area network, wide area network, cellular network, etc. As yet another example, targeted promotional information may be generated for the user. Once accessed, obtained, and/or generated, the promotional information may be formatted for communication to one or more mobile assets 105, 110.

A wide variety of different types of promotional information may be communicated to one or more mobile assets 105, 110 associated with a user, for example, textual information, images, multimedia presentations, hyperlinks and or location identifiers that may be utilized to obtain additional information, audio presentations, audio files that include inaudible tones that may be output by a mobile asset 105, 110 or other device, etc. Additionally, the promotional information may be communicated to a mobile asset 105, 110 in a wide variety of different formats, for example, email messages, SMS or text messages, mobile browser communications, web access portal (WAP) communications, communications to an electronic wallet associated with the mobile asset, and/or telephone calls. In certain embodiments, one or more suitable IVR systems 150 incorporated into or in communication with the promotional information server 115 may be utilized to initiate and/or established communication with a mobile asset 105, 110 via a cellular network, public switch telephone network, or other suitable network. The IVR systems 150 may then communicate promotional information to the mobile asset 105, 110 via an established communication session.

With continued reference to the promotional information server 115 of FIG. 1, the one or more I/O interfaces 133 may facilitate communication between the promotional information server 115 and one or more input/output devices, for example, a keyboard, mouse, display, keypad, control panel, touch screen display, remote control, microphone, disc drive, CD-ROM drive, infrared receiver, a device connected via a universal serial bus (USB) port, a device connected via a serial port, etc. In this regard, input associated with the operation of the promotional information server 115 may be received and information processed by the promotional information server 115 may be output. The one or more network interfaces 134 may facilitate connection of the promotional information server 115 to one or more suitable networks, for example, networks 125. In this regard, the promotional information server 115 may receive requests for promotional information and may communicate promotional information to one or more mobile assets 105, 110. Additionally, the promotional information server 115 may communicate with external data sources and/or systems 145 as desired.

Embodiments of the invention may include promotional information servers 115 with more or less than the components illustrated for the promotional information server 115 illustrated in FIG. 1. The description of the promotional information server 115 of FIG. 1 is provided by way of example only and is not intended to be limiting.

Additionally, certain components of the system 100 are described as having any number of processors or processing components. Operations may be completed by the one or more processors as desired in various embodiments of the invention. A different processor may be provided to complete or facilitate each operation of a system component, or alternatively, multiple operations may be completed or facilitated by a single processor. For example, a first processor of the promotional information server 115 may facilitate the receipt and initial processing of a request for promotional information; a second processor may facilitate the identification of one or more items of promotional information; a third processor may facilitate the generation of promotional information; a fourth processor may facilitate the formatting of promotional information for communication to a mobile asset; and fifth processor may facilitate directing the communication of the promotional information to a mobile asset. As desired, two or more of the first, second, third, fourth, and fifth processors may be the same processor. Although the example above relates to the operations of the promotional information server 115, the operations of other components of the system 100, such as a mobile asset 105, 110 may be completed and/or facilitated in a similar manner.

A wide variety of mobile assets may be utilized in various embodiments of the invention; however, as desired in various embodiments, different types of mobile assets may include one or more similar components. FIG. 2 is a schematic diagram of example components of an example mobile asset 200, such as the mobile device 105 or the motor vehicle 110 illustrated in FIG. 1. The components illustrated in FIG. 2 are example components of a generic mobile asset 200 that are provided by way of example only. It will be appreciated that various mobile assets may include less than or more than the components illustrated in FIG. 2.

With reference to FIG. 2, the mobile asset 200 may be any suitable or appropriate device or system that facilitates the request of promotional information, the receipt of promotional information, and/or the presentation of promotional information to a user. Additionally, in certain embodiments, the mobile asset 200 may include functionality that facilitates the determination of location information associated with the mobile asset 200, such as a current location of the mobile asset 200 and/or one or more proposed future locations or destinations of the mobile asset 200. Additionally, as desired in certain embodiments, the mobile asset 200 may be operable to output one or more tones for receipt by another device, such as a merchant point of sale device.

The mobile asset 200 may be a processor driven device that facilitates the request, receipt, and/or processing of promotional information. For example, the mobile asset 200 may include any number of special purpose computers or other particular machines, application specific circuits, microcontrollers, and the like. In certain embodiments, at least a portion of the operations of the mobile asset 200 may be controlled by computer-executed or computer-implemented instructions that are executed by one or more processors associated with the mobile asset 200. The instructions may be embodied in one or more software components as desired in various embodiments of the invention. The execution of the instructions may form a special purpose computer or other particular machine that is operable to request, receive, and/or process promotional information. Additionally, in certain embodiments of the invention, the operations and/or control of the mobile asset 200 may be distributed amongst several processing components.

The mobile asset 200 may include one or more processors 201, one or more memory devices 202, one or more input/output (I/O) interface(s) 203, and one or more network interface(s) 204. The one or more memory devices 202 may be any suitable memory devices, for example, caches, read only memory devices, random access memory devices, magnetic storage devices, etc. The one or more memory devices 202 may store data, executable instructions, and/or various program modules utilized by the mobile asset 200, for example, stored promotional data and other stored data 205 that is received by the mobile asset 200, an operating system 206, a promotional information application 207, and a tone processing application 208, and/or a user profile 209. The stored data 205 may include any suitable promotional information that is received from a promotional information server, such as server 115, from another mobile asset, and/or from other sources of promotional information. For example, the stored data 205 may include textual information, images, and/or audio files associated with promotional information.

In certain embodiments of the invention, the mobile asset 200 may include one or more software modules, such as an operating system 206, a promotional information application 207, and/or a tone processing application 208. The operating system 206 may control the general operation of the mobile asset 206, for example, the completion of telephone calls, the maintenance of an address book, the accessing of the Internet via a mobile browser application, the display of information to a user, etc. The operating system 206 may also facilitate the execution of other software modules by the one or more processors 201, for example, the promotional information application 207 and/or the tone processing application 208.

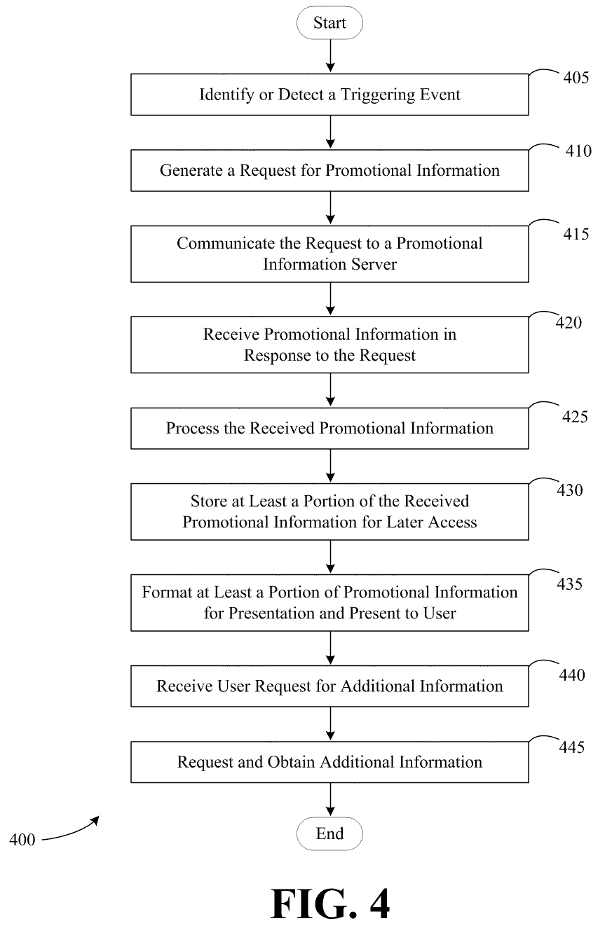

The promotional information application 207 may include computer-executable instructions that facilitate the identification or detection of one or more triggering events for requesting promotional information as explained in greater detail below with reference to FIG. 4. The promotional information application 207 may further include computer-executable instructions that request or direct the request of promotional information from the promotional information server 115. In certain embodiments, the promotional information application 207 may generate requests for promotional information. These requests may include a wide variety of information as desired, such as location information (e.g., GPS coordinates) of the mobile asset 200 and/or user preferences relating to the types of promotional information that the user desires and/or wishes not to receive. In certain embodiments, the promotional information application 207 may further include computer-executable instructions that facilitate the receipt and/or processing of promotional information.

Processing of promotional information may include, for example, storage of the promotional information, communication of promotional information to another device, such as another mobile asset, and/or presentation of certain promotional information to a user of a mobile asset 200. For example, textual promotional information, promotional images, and/or hyperlinks and other location identifiers may be presented to a user of the mobile asset 200 via a suitable display or other output device. As another example, audio promotional information may be presented to a user via one or more suitable speakers or other output devices. In certain embodiments, a user may request additional promotional information associated with promotional information that has been presented to the user. For example, a user may select a hyperlink to request additional promotional information. As another example, the user may respond to an audio prompt to request additional promotional information by uttering a requested word or phrase or by selecting one or more appropriate keys on an input device (e.g., keyboard, selectable display, etc.) associated with the mobile asset 200. Once additional promotional information is requested by a user, the mobile asset 200 may request or direct the request of the additional promotional information from the promotional information server 115 and/or from one or more other suitable data sources, such as a data source identified in the original promotional information. Additional promotional information may then be received and processed by the promotional information application 207 in a similar manner as the original promotional information.

Additionally, in certain embodiments, at least a portion of received promotional information may be stored in one or more memory devices associated with the mobile asset 200. In certain embodiments, the promotional information may be associated with a particular offer for the user. For example, the promotional information may include a coupon. Promotional information may be presented and/or output be the mobile asset 200 at a merchant location or at a merchant point of sale terminal. Promotional information may be presented to a merchant in a wide variety of different ways as desired in various embodiments of the invention. In certain embodiments, textual information and/or images may be output by the mobile asset 200 on one or more displays that can be viewed by a merchant. For example, a coupon may be displayed for viewing by an individual associated with a merchant. As another example, a machine readable barcode may be displayed by the mobile asset 200, and the machine readable barcode may be scanned by an appropriate barcode reader at a merchant terminal. In other embodiments, promotional information may be communicated by the mobile asset 200 to a merchant terminal or other merchant device via one or more suitable networks and/or network connections, for example, a wireless network, a wired network, wide area network, the Internet, a Bluetooth enabled network, a WiFi enabled network, a cellular network, a public switch telephone network, a radio frequency network, or any other network capable of communicating data. In other embodiments, the promotional information may include one or more audio files that may be output by the mobile asset 200 as one or more tones (e.g., inaudible tones) for receipt by a merchant terminal or other merchant device. As desired, the processing of one or more audio files to output one or more tones may be accomplished by the tone processing application 208.

The tone processing application 208 may include computer-executable instructions that facilitate the processing of one or more promotional information audio files to output tones. For example, the tone processing application 208 may facilitate and/or control, the processing of received audio files to output tones that include data that may be extracted by a recipient device, such as a merchant terminal. The data may include, for example, information associated with a promotional offer and/or one or more location identifiers that may be utilized to access and/or obtain information associated with a promotional offer. The tone processing application 208 may direct the output of one or more audio files, for example, a Waveform audio format (WAV) file, MPEG-1 Audio Layer 3 (MP3) file, Moving Picture Experts Group (MPEG) file, Audio Interchange File Format (AIFF) file, Advanced Audio Coding (AAC) file, Apple Lossless file, or other digital media file format, that include tones via one or more suitable output devices associated with the mobile asset 200 and/or another device, such as another mobile asset in communication with the mobile asset. For example, the tone processing application 208 may direct the output of an audio file via one or more speakers 210 associated with the mobile asset 200. As desired, a digital audio file may be processed through one or more digital to analog (D/A) converters before being output by the one or more speakers 210 as analog data. In other words, the digital audio information may be converted or transformed into analog data that is output. Once output, a tone may be received by an input devices, such as a microphone, associated with a merchant terminal or merchant device. The received tone may be processed by the merchant terminal, and data included in the tone may be extracted by the merchant terminal. In this regard, a special offer, such as a coupon, may be communicated to the merchant terminal by the mobile asset 200 utilizing one or more tones. Although the tone processing application 208 is illustrated as a single software component, the tone processing application 208 may include any number of software components, modules, and/or applications as desired in various embodiments of the invention.

The user profile 209 may include one or more preferences and/or other information associated with one or more users of the mobile asset 200. In certain embodiments, the user profile 200 may include one or more user preferences associated with types of promotional information that may be received and processed by the mobile asset 200. For example, the user profile 200 may include preferences indicating that certain promotional information should be or should not be received and/or processed by the mobile asset 200. In this regard, promotional information may be filtered by the mobile asset 200. Additionally or alternatively, preferences may be communicated to the promotional information server 115 along with a request for promotional information, and the promotional information returned to the mobile asset 200 may take the preferences into account. Additionally, in certain embodiments, preferences may be stored in a memory associated with the promotional information server 115. A wide variety of different preferences and/or criteria may be utilized as desired in various embodiments, including but not limited to, types of products and/or product offers that the user is interested in receiving, merchant criteria, merchant class or merchant type criteria, etc. Moreover, according to one embodiment, the user profile 209 may include information associated with the user of the mobile asset 200, such as, but not limited to, name information, username, account information, billing information, and the like.

In certain embodiments, the mobile asset 200 may include or be in communication with one or more GPS devices 215. The GPS devices 215 may facilitate the determination of location information associated with the mobile asset 200. Additionally, as desired, the GPS devices 215 may facilitate the receipt and/or determination of one or more desired destinations of the user associated with the mobile asset 200, for example, one or more desired end points selected by the user and/or one or more locations that the user is expected to pass through or travel near based on a desired end point or a current trajectory or travel path of the user. Location information and/or other information may be obtained from the GPS devices 215 by the promotional information application 207 and, in some embodiments, utilized in the determination of triggering events. Additionally, location information and/or other information obtained from the GPS devices 215 may be communicated to the promotional information server 115 by the promotional information application 207, and the promotional information that is returned by the server 115 may be based at least in part on the location information. For example, the promotional information returned by the server may include one or more offers associated with merchants near the location of the mobile asset 200 and/or within a travel path of the mobile asset 200. As one example, promotional information may be provided for gas stations, restaurants, retail establishments, and/or tourists attractions near the location of the mobile asset 200 and/or within or near a travel path of the mobile asset 200. The location information may be communicated to the server 115 along with a request for promotional information and/or in response to a request for the promotional information that is received from the server 115 by the mobile asset 200.

Additionally, in certain embodiments, the mobile asset 200 may include or be in communication with one or more accelerometers 220. The accelerometers 220 may facilitate the determination of a rate of velocity of the mobile asset 200. For example, the accelerometers 220 may determine that the mobile asset 200 is traveling at a certain rate of speed. As desired, determinations and/or measurements taken by the accelerometers 220 may be processed through one or more analog to digital (A/D) converters 221 and passed to the promotional information application 207 for processing. As desired, data received from the accelerometers 220 may be combined with location data associated with that taken from the GPS devices 215. In certain embodiments, the detection of a rate of speed or rate of velocity that satisfies a threshold value may trigger a request for promotional information. For example, a determination may be made that the mobile asset 200 is traveling at least at a threshold velocity, such as 30 miles per hour, 50 miles per hour, etc. The determination may indicate that the user of the mobile asset 200 is traveling in an automobile or other mobile vehicle, and a request for promotional information may be made based at least in part on this determination.

The one or more I/O interfaces 203 may facilitate communication between the mobile asset 200 and one or more input/output devices, for example, one or more user interface devices, such as, a display, keypad, control panel, touch screen display, remote control, microphone, speakers, etc. that facilitate user interaction with the mobile asset 200. In this regard, one or more user preferences associated with the operation of the mobile asset 200 may be received and processed.

The one or more network interfaces 204 may facilitate connection of the mobile asset 200 to one or more suitable networks, such as the networks 125 illustrated in FIG. 1. In this regard, the mobile asset 200 may communicate with the promotional information server 115, one or more IVR systems 150, one or more merchant terminals or merchant devices, etc. The one or more network interfaces 204 may also facilitate communication between the mobile asset 200 and another mobile asset via one or more suitable connections, such as the connections 112 illustrated in FIG. 1 (e.g., a Bluetooth connection). The mobile asset 200 may utilize a wide variety of different techniques, methods, and/or systems to communicate with other devices or systems, such as the promotional information server 115. For example, a mobile Internet browser or other specific purpose or dedicated application may facilitate communication between the mobile asset 200 and the promotional information server 115. As another example, short message service (SMS) communications may be utilized to facilitate communication between the mobile asset 200 and the promotional information server 115.

Embodiments of the invention may include mobile assets with more or less than the components illustrated for the mobile asset 200 illustrated in FIG. 2. The description of the mobile asset 200 of FIG. 2 is provided by way of example only and is not intended to be limiting.

Although FIG. 2 has been described as having specific functions performed by specific components of the mobile asset 200, various functions and/or operations of embodiments of the invention may be performed by any suitable component of the mobile asset 200. Additionally, various operations may be completed in a distributed manner by multiple components of the mobile asset 200.

Illustrative Data Flow

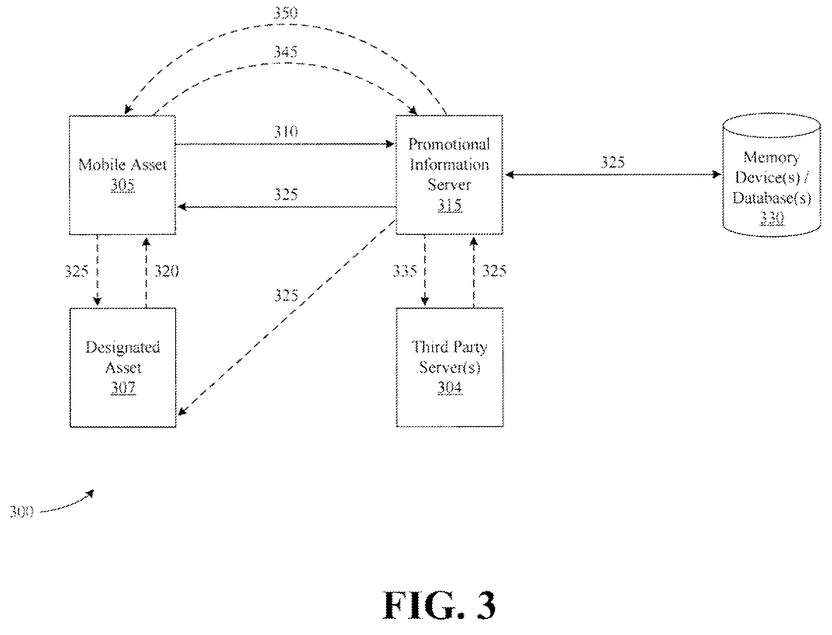

FIG. 3 is a diagram of one example data flow 300 of requesting promotional information by a mobile asset and communicating promotional information to the mobile asset, according to an illustrative embodiment of the invention. The data flow 300 may be applicable to a wide variety of systems utilized to communicate promotional information to one or more mobile assets, including but not limited to, the system 100 illustrated in FIG. 1.

With reference to FIG. 3, a mobile asset 305, such as a mobile asset similar to the mobile asset 200 illustrated in FIG. 2, may communicate a request 310 for promotional information to a promotional information server 315, such as a server similar to the server 115 illustrated in FIG. 1. The request may be communicated by the mobile asset 305 based at least in part on the detection of a triggering event by the mobile asset 305 or by a device in communication with the mobile asset 305, such as another mobile asset. For example, the mobile asset 305 may detect a triggering event, such as a Bluetooth sync with a predetermined device (e.g., a Bluetooth sync between a mobile device and an automobile), a deactivation of a predetermined network connection (e.g., a deactivation of a mobile asset from a home WiFi network), an interaction with a predetermined device or system (e.g., a toll booth interaction or merchant interaction), the receipt of a message from another device (e.g., the receipt of a near field communications message as the mobile asset crosses an intersection), a switching between cellular towers or relays, a detection of a velocity or rate of speed that satisfies a predetermined threshold, a GPS proximity move outside of a predetermined area (e.g., a move outside of a user's home), a search on a GPS, another search utilizing the mobile asset (e.g., an Internet search), a detection of a motor vehicle ignition, a payment event (e.g., a tollbooth payment event, point of sale payment event, etc.), etc. In certain embodiments, the mobile asset 305 may initiate the generation and/or communication of the request to the promotional information server 315. In other embodiments, the mobile asset 305 may communicate the request 310 at the direction 320 of another device, such as another mobile asset. For example, a motor vehicle may detect a triggering event and direct a mobile device to communicate a request for promotional information to the promotional information server 315.

The request 310 for promotional information may include a wide variety of information as desired in various embodiments of the invention. For example, in certain embodiments, the request 310 may include an identifier of the mobile asset 305 or an identifier of another device, such as another mobile asset or a designated asset 307. Suitable identifiers may include, for example, a telephone number associated with a mobile asset, a universal integrated circuit card (UICC) identifier, a subscriber identity module (SIM) card identifier, an international mobile subscriber identity (IMSI) number associated with a mobile asset, or any other identifier that facilitates communication with an information source (e.g., a back-end processor Mobile Gateway identifier). The identifier may be utilized by the promotional information server 315 to communicate promotional information to the mobile asset 305. As another example, in certain embodiments, the request 310 may include location information, destination information, and the like, associated with the mobile asset 305. As yet another example, in certain embodiments, the request 310 may include a user identifier and/or various user preferences that may be utilized by the promotional information server 315 to identify one or more items of promotional information to return in response to the request.

The promotional information server 315 may receive the request 310 for promotional information and identify one or more items of promotional information to return in response to the request 310. The identification of promotional information 325 to communicate in response to the request 310 may be based on a wide variety of different factors, including but not limited to, the identity of the user, stored preferences associated with the user, received preferences associated with the user, a location of the mobile asset 305, a time of day, a day of week, etc. For example, promotional information may be selected for merchants that are near the location of the mobile asset 305. As an example of selecting promotional information based on the time of day, promotional information for breakfast food offers may be selected in the morning. As an example of selecting promotional information based on a day of week, promotional information for a car wash offer or home improvement offers may be selected on a weekend day.

The promotional information server 315 may access promotional information 325 from one or more memory devices and or associated databases 330 associated with the promotional information server 315. Additionally or alternatively, the promotional information server 315 may obtain promotional information 325 from one or more third party data servers 340 and/or third party data sources. For example, the promotional information server 315 may communicate a request 335 for promotional information to a third party server 340 and promotional information 325 may be communicated to the promotional information server 315 in response to the request 335. Once the promotional information 325 has been accessed and/or obtained by the promotional information server 315, the promotional information 325 may be communicated to the mobile asset 305 and/or to a designated asset 307 (e.g., another mobile asset identified in the request 310) associated with the mobile asset 305. The promotional information 325 may be communicated via a wide variety of different techniques, for example, via a network communication, via one or more web access portal (WAP) sites or communications, via a communication to an electronic wallet associated with a mobile asset, via email, via SMS messaging, and/or via telephone calls initiated by one or more IVR systems. Additionally, the promotional information 325 may include a wide variety of different types of information, including but not limited to, textual information, images, audio information, audio files, hyperlinks and/or other location identifiers, etc.

Once received by the mobile asset 305 and/or the designated asset 307, at least a portion of the promotional information 325 may be presented to a user via one or more suitable output devices associated with and/or in communication with the mobile asset 305 or designated asset 307, such as a liquid crystal display (LCD), another display, one or more speakers, etc. In certain embodiments, the promotional information 325 may be presented by the receiving device. In other embodiments, the promotional information 325 may be communicated by the receiving device to another device for presentation. For example, the promotional information 325 may be received by the mobile asset 305 and communicated to the designated asset 307 for presentation to the user. As another example, promotional information 325 may be received by the designated asset 307 and communicated to the mobile asset 305 for presentation to the user.

Additionally, in certain embodiments of the invention, promotional information 325 may be presented or output by the mobile asset 305 or designated asset 307 to a merchant, merchant terminal, or merchant device. For example, a coupon may be output on a display for viewing by a merchant. As another example, a machine readable barcode may be output on a display, and the barcode may be scanned at a merchant terminal or by a merchant device. As yet another example, one or more tones may be output for receipt by a merchant terminal or merchant device.

As desired in various embodiments of the invention, additional information associated with the promotional information 325 may be requested by the mobile asset 305 or designated asset 307. For example, a user may select a hyperlink included in the promotional information 325 to request additional information. As another example, a user may select an appropriate key or say an appropriate command in response to a prompt included in the promotional information 325 (e.g., a prompt included in an IVR system initiated call) to request additional information. A request 345 for additional information may be communicated to the promotional information server 315 or to another data source, and additional promotional information 350 may be communicated to the mobile asset 305 or designated asset 307 in response to the request 345.

Many variations may be made to the data flow 300 illustrated in FIG. 3 as desired in various embodiments of the invention. For example, the roles of the mobile asset 305 and the designated asset 307 may be reversed. The data flow 300 is not intended to be limiting, but instead is provided by way of example only as an illustrative embodiment of the invention.

Illustrative Methods of Various Embodiments of the Invention

FIG. 4 is a flowchart of one example method 400 for soliciting promotional information by a mobile asset, such as the promotional asset 200 shown in FIG.2, according to an illustrative embodiment of the invention. The method 400 is described with respect to operations that are performed by a single mobile asset 200; however, in various embodiments of the invention, operations may be distributed among several mobile assets and/or other devices. For example, operations may be distributed amongst a mobile device and a motor vehicle, such as the mobile device 105 and motor vehicle 110 illustrated in FIG. 1.

The method 400 may begin at block 405. At block 405, one or more triggering events may be detected or identified by a mobile asset 200. In certain embodiments of the invention, the one or more triggering events may indicate that a user of the mobile asset 200 is in a motor vehicle or traveling via a motor vehicle. In other embodiments of the invention, the one or more triggering events may indicate that the user is located outside of the user's home or at predetermined locations, such as at a merchant location. A wide variety of different triggering events may be identified as desired in various embodiments of the invention. Example triggering events include, but are not limited to, a Bluetooth or other synchronization, a home event, a travel event, an identification of a predetermined velocity or rate of speed, a determination of a predetermined movement, a determination of an ignition of a motor vehicle, a payment event, and/or an identification of the execution of one or more software programs on the mobile asset, etc. An example of a synchronization triggering event may include the identification of a wired connection, Bluetooth enabled connection, or other connection between the mobile asset 200 and a designated device (e.g., another mobile asset, a mobile device, a motor vehicle, etc.). An example of a home event may include the detection of a deactivation of the mobile asset from a home network, such as a home WiFi network, thereby indicating that the mobile asset and the user have left the user's home. Another example of a home event may include the detection of a GPS proximity move from a predetermined area, such as the detection of a move from a predetermined area associated with the user's home (e.g., an area with a 100 foot circumference around the user's home). An example of a travel event may include the detection of an interaction with a predetermined device or system, such as the detection of a toll booth interaction by a mobile asset or the detection of a connection with a WiFi network, such as a free WiFi network offered by a merchant. Another example of a travel event may include the detection of a search by the user, such as a GPS search made by the user or a mobile browser search made by the user. Another example of a travel event may include the detection of a switch between service providers or service points, such as a detection of a cellular tower switching. Yet another example of a travel event may include the receipt of a message during travel, such as the receipt of a near field communication (NFC) message that is pushed to a mobile asset at an intersection, merchant location, etc. An example of an identification of a predetermined velocity event may include a determination using one or more accelerometers that the mobile asset 200 is traveling at a velocity that exceeds a predetermined threshold velocity, such as 30 miles per hour, 50 miles per hour, etc. An example of a determination of a predetermined movement may include an identification of a change in a GPS position associated with the mobile asset 200. In some embodiments, the identification of a change in a GPS position may be identified as a change that occurs within a predetermined period of time, thereby indicating that the mobile asset 200 is traveling at least at a threshold velocity. Examples of payment events may include interaction with a tollbooth system, transit system (e.g., bus, subway, etc.), merchant interactions, point of sale purchases, etc.). Additionally, as desired, the types of triggering events that are identified may be based at least in part on the capabilities and/or functionalities of the mobile asset 200. For example, if the mobile asset 200 is a mobile device 105, then identified triggering events may include synchronization events, predetermined movement events, and/or predetermined velocity events. As another example, if the mobile asset 200 is a motor vehicle 110, then identified triggering events may include synchronization events, predetermined movement events, predetermined velocity events, and/or ignition events.

Once one or more triggering events are detected at block 405, operations may continue at block 410. At block 410, a request for promotional information may be generated. A wide variety of information may be included in the generated request as desired in various embodiments of the invention, including but not limited to, identifiers of one or more mobile assets or other devices to which promotional information should be communicated, identification information for a user of the mobile asset 200, one or more user preferences associated with promotional information to be received, one or more user profiles, location information (e.g., GPS information) for the mobile asset 200, predicted or planned routes of travel for the mobile asset 200, one or more planned destinations of the mobile asset 200, etc. At least a portion of the information included in the request may be utilized by a promotional information provider, such as the promotional information server 115 illustrated in FIG. 1, to identify promotional information to return in response to the request.

At block 415, the generated request may be communicated to a promotional information server 115 via one or more suitable networks, such as the one or more networks 125 illustrated in FIG. 1. In certain embodiments of the invention, the mobile asset 200 may communicate the request to the promotional information server 115. In other embodiments of the invention, the mobile asset 200 may direct another device, such as another mobile asset, to communicate the request to the promotional information server 115. Once received by the promotional information server 115, the promotional information server 115 may identify one or more items of promotional information to return in response to the request. The promotional information server may then communicate promotional information to the mobile asset 200 and/or to one or more other designated devices operable to receive the promotional information. Promotional information may be communicated from the promotional information server 115 via a wide variety of suitable methods, for example, via a network connection, via email, via SMS messaging, via telephone calls initiated by one or more IVR systems, etc. Additionally, the promotional information may include a wide variety of different types of information, including but not limited to, textual information, images, machine readable barcode images, audio files that may be output to the user or other individual, audio files that include one or more tones that may be output for receipt by a merchant terminal or other merchant device, etc.

At block 420, the mobile asset 200 may receive promotional information that is communicated by the promotional information server 115 in response to the request. The promotional information may be directly received by the mobile asset 200 and/or indirectly received via another device, such as another mobile asset.

At block 425, the mobile asset 200 may process the received promotional information. The promotional information may be processed in a wide variety of different ways as desired in various embodiments of the invention. For example, the promotional information may be filtered utilizing one or more user preferences and undesired promotional information may be deleted.

At block 430, at least a portion of the received promotional information may be stored in one or more suitable memory devices associated with the mobile asset 200 for later access. The stored promotional information may be access for later presentation to a user, for presentation to a merchant, and/or for communication to a merchant point of sale terminal or other merchant device. For example, a user may review stored promotional information at the user's convenience. As another example, an offer, coupon, or other promotional information may be presented to a merchant. As yet another example, a machine readable barcode image may be displayed at a merchant, and the machine readable barcode may be read by a suitable scanning device associated with the merchant. As yet another example, an audio file containing one or more tones may be output at a merchant location, and the one or more tones may be received by a merchant terminal or other merchant device. As yet another example, information associated with an offer may be communicated to a merchant via any number of suitable networks and/or communications techniques, such as a wide area network (e.g., the Internet), a near field communications (NFC) data transfer and/or one or more NFC pushes from the mobile asset, a radio frequency network communication, a Bluetooth communication, a WiFi communication, etc. In this regard, special offers, coupons, etc., may be redeemed at a merchant location.

At block 435, at least a portion of the received promotional information may be formatted for presentation to a user of the mobile asset 200, and promotional information may be presented to the user. A wide variety of different techniques may be utilized as desired to present promotional information to a user. For example, textual information, images, hyperlinks, etc. may be presented to the user via one or more suitable displays, such as a LCD display or touch screen display. As another example, audio information may be output for the user via one or more suitable speakers. In certain embodiments, the promotional information may be directly presented to the user by the mobile asset 200. In other embodiments, the promotional information may be presented to the user via one or more other mobile assets, designated devices, and/or other devices in communication with and/or at the direction of the mobile asset 200. Any number of offers may be displayed at once as desired. Additionally, when multiple offers are displayed, the offers may be categories and/or arranged in a wide variety of different formats. In certain embodiments of the invention, one or more offers may be displayed to the user via a map of offers. For example, offers may be displayed on a GPS map in which offers are overlaid on the GPS map. As another example, offers may be displayed on a map provided by a web access portal or via a web server.

At block 440, which may be optional in various embodiments of the invention, a user request for additional information associated with received promotional information may be received. A user request for additional information may be received using a wide variety of suitable methods and techniques as desired in various embodiments of the invention. For example, a user may select a hyperlink included in displayed promotional information in order to select additional information. As another example, the user may select a key or orally request additional information in response to a prompt presented to the user in the promotional information.

Once the user requests additional information at block 440, operations may continue at block 445, which may be optional in various embodiments of the invention, and a request for additional information may be communicated to one or more suitable data sources, such as the promotional information server 115 or another suitable data source. In some embodiments, the data source may be identified in the original promotional information. For example, the data source may be identified by a hyperlink. As with the request for promotional information at block 415, the request for additional information may be directly or indirectly communicated from the mobile asset 200 to one or more data sources. In certain embodiments, the additional information may then be directly or indirectly received by the mobile asset 200 in response to the request for the additional information.

The method 400 may end following block 445.

FIG. 5 is a flowchart of one example method 500 for processing promotional information requests received from a mobile asset, according to an illustrative embodiment of the invention. The method 500 may be performed by a promotional information server, such as the promotional information server 115 illustrated in FIG. 1.

The method 500 may begin at block 505. At block 505, the promotional information server 115 may receive a request for promotional information. The request may be received from a mobile asset, such as the mobile asset 200 illustrated in FIG. 2. The request may be received via any number of suitable networks, such as the one or more networks 125 illustrated in FIG. 1. Additionally, the request may be received utilizing a wide variety of different techniques and/or technologies, such as a mobile browser, email, SMS messaging, etc. A wide variety of information may be included in the request or subsequently obtained from the mobile asset 200 by the promotional information server 115 as desired in various embodiments of the invention, for example, an identifier of the mobile asset 200 (e.g., telephone number, a universal integrated circuit card (UICC) identifier, a subscriber identity module (SIM) card identifier, an international mobile subscriber identity (IMSI) number, etc.), an identifier of another device, such as another mobile asset, to which promotional information should be communicated, a user identifier, a user profile, one or more user preferences for receiving promotional information, location information associated with the mobile asset 200, planned and/or expected routes associated with the mobile asset 200, and/or planned destinations associated with the mobile asset 200.

At block 510, a location of the mobile asset 200 may be determined by the promotional information server 115. In certain embodiments, the location of the mobile asset 200 may be determined utilizing location information received from the mobile asset 200 in the request and/or in response to a request for the location information that is communicated to the mobile asset 200 by the promotional information server 115. In other embodiments, the location of the mobile asset 200 may be obtained from another source, for example, another mobile asset in proximity to the mobile asset 200, a cellular provider associated with the mobile asset 200, a concierge service associated with the mobile asset 200, a motor vehicle network service provider (e.g., OnStar, BMW Connected Drive, etc.), etc. In addition to determining a location of the mobile asset 200, in certain embodiments, expected routes of travel and/or expected destinations of the mobile asset 200 may be determined.

At block 515, at least one user profile associated with a user of the mobile asset may be accessed and/or obtained from one or more memory devices associated with the promotional information server 115 and/or from one or more third party data sources. For example, a user profile may be accessed or obtained using a user identifier or mobile asset identifier. In certain embodiments, the user profiles may include user preferences associated with the types of promotional information that the user desires. Additionally, in certain embodiments, the user profiles may include a purchasing history or offer acceptance history associated with the user. Furthermore, in certain embodiments, the user profiles may include various demographic information associated with the user. The information included in the user profiles may be utilized to determine one or more items of promotional information that will be returned in response to the request for promotional information. As an alternative to accessing or obtaining a user profile, a user profile and/or user preferences may be received from the mobile asset 200.

At block 520, the promotional information server 115 may identify one or more items of promotional information to communicate to the mobile asset 200 and/or one or more other devices in response to the received request for promotional information. The items of promotional information may be identified based on a wide variety of different factors as desired in various embodiments, including but not limited to, demographic information associated with the user, user preferences, a purchasing history of the user, an offer acceptance history of the user, location information of the mobile asset 200, expected destinations of the mobile asset 200, expected routes of travel of the mobile asset 200, a time of day, a day of week, etc. The identified promotional information may be obtained from memory and/or from one or more third party data sources and/or formatted for communication to the user.

At block 525, the identified promotional information may be communicated to the mobile asset 200 and/or to one or more other devices (e.g., another mobile asset, a designated receiving device, etc.). A wide variety of communications techniques, systems, and/or devices may be utilized to communicate promotional information from the promotional information server 115. For example, textual information, images, and/or audio files may be communicated via a wide area network (e.g., the Internet via a mobile browser), via a web access portal (WAP), via a communication to an electronic wallet (eWallet) of a mobile asset, via email, and/or via SMS messaging. As another example, one or more IVR systems, such as the IVR systems 150 illustrated in FIG. 1, may establish a communications session with a receiving device via a cellular network or public switched telephone network, and the IVR systems 150 may communicate audio information to the receiving device for presentation or output to the user.

As desired in certain embodiments of the invention, a user may request additional information associated with received promotional information. For example, the user may select a hyperlink included in received promotional information in order to request additional information, such as additional information about a product or offer, a coupon associated with a product or offer, a customer survey, etc. These requests may be communicated to the promotional information server 115 and/or to one or more third party data sources, such as third party data sources identified by the promotional information. At block 530, a request for additional information may be received by the promotional information server 115. The promotional information server 115 may access and/or obtain the additional information from memory and/or from one or more third party data sources, and the additional information may be communicated to the mobile asset 200 and/or one or more other devices (e.g., a designated device) at block 535.

The method 500 may end after block 535.

The operations described in the methods 400 and 500 illustrated in FIGS. 4 and 5 do not necessarily have to be performed in the order set forth in FIGS. 4 and 5, but instead may be performed in any suitable order in various embodiments of the invention. Additionally, more or less than all of the steps illustrated in the methods 400 and 500 may be performed as desired in various embodiments of the invention.

Accordingly, example embodiments provide systems and methods that facilitate communicating promotion information to a mobile asset. The mobile asset may detect one or more triggering events and request promotional information, and promotional information may be returned in response to the request for presentation to a user. By communicating information to a mobile asset, more potential customers may be reached, due to the simplicity of interacting with the mobile assets and the immediate results made possible by real-time messaging with central and/or third party information sources. Moreover, promotion sponsors may benefit by being able to run more targeted promotions, and promotions have more exclusive, limited terms, by being able to validate and activate a promotion for each consumer upon initial contact with that individual via communicating with the mobile asset. In addition, the real-time or near real-time validation and activation of the promotion for a consumer provides additional incentive for the consumer to immediately redeem the promotion due to the convenience.

Example embodiments can provide the technical effects of creating certain systems and methods for communicating promotion information to a mobile asset operator. Example embodiments can provide the further technical effects of providing mobile assets that request promotional information based upon the detection of one or more triggering events, such as triggering events that indicate that a user is in a motor vehicle. Additionally, in certain embodiments, targeted promotional information may be communicated to mobile assets based upon the location of the mobile asset and/or one or more other factors, such as the time of day or day of week.

Embodiments of the invention have been described herein with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

In certain embodiments, performing the specified functions, elements or steps can transform an article into another state or thing. For instance, example embodiments can provide certain systems and methods that transform a tone or multiple tones to a redeemable promotion, as described above. Example embodiments can provide the further systems and methods for that transform a tone or multiple tones to a coupon or other paper certificate, which may be physically presented and redeemable at a transaction terminal in association with a promotion, as described above.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for soliciting promotional information by a mobile asset, the method comprising:
detecting a triggering event for soliciting promotional information;
communicating, based on the detection, a request for promotional information to a promotional information server;
receiving the promotional information in response to the request; and
presenting at least a portion of the promotional information to a user by a designated asset,
wherein at least one of the prior steps is performed by one or more computers associated with the mobile asset.

2. The method of claim 1, wherein the triggering event comprises at least one of detecting Bluetooth syncing with a predetermined device, detecting an ignition of a motor vehicle, detecting a move from a predetermined location, detecting a payment event, receiving a near field communications message, or detecting a predetermined movement.

3. The method of claim 1, wherein the request for the promotional information comprises location information associated with the mobile asset.

4. The method of claim 1, wherein the request for the promotional information is communicated to the promotional information server by one or more of a wide area network, cellular network, or public switch telephone network.

5. The method of claim 1, wherein the promotional information is received by one or more of a wide area network, cellular network, or public switch telephone network.

6. The method of claim 1, wherein the content of the promotional information is based at least in part on one or more of a user preference, a time of day, a day of week, a location of the mobile asset, or a movement of the mobile asset.

7. The method of claim 1, wherein the promotional information is formatted as one of an e-mail, a text message or a telephony call.

8. The method of claim 1, wherein the promotional information includes one or more of an audio file, an image, a location identifier, or text.

9. The method of claim 8, wherein the promotional information includes an audio file containing an inaudible tone message.

10. The method of claim 8, wherein the promotional information includes an image that is machine readable.

11. The method of claim 7, wherein the promotional information includes a telephony call initiated by an IVR system.

12. The method of claim 1, wherein at least a portion of the received promotional information is presented to a merchant for redemption via a near field communications message.

13. The method of claim 1, wherein the mobile asset and the designated asset are the same.

14. The method of claim 1, further comprising transmitting the at least a portion of the promotional information from the mobile asset to the designated asset for presentation to the user.

15. The method of claim 1, wherein the mobile asset comprises a mobile phone, a personal digital assistant, or a motor vehicle.

16. A system operable to solicit promotional information, the system comprising:
a network interface operable to communicate a request for promotional information to a promotional information server and to receive the promotional information in response to the request; and
at least one processor operable (i) to detect a triggering event for soliciting promotional information, (ii) to direct the network interface to communicate the request based upon the detection, and (iii) to direct the presentation of at least a portion of the received promotional information to a user.

17. The system of claim 16, wherein the triggering event comprises at least one of detecting Bluetooth syncing with a predetermined device, detecting an ignition of a motor vehicle, detecting a move from a predetermined location, detecting a payment event, receiving a near field communications message, or detecting a predetermined movement.

18. The system of claim 16, further comprising:
a global positioning system (GPS) component operable to determine a location associated with the mobile asset,
wherein the request for the promotional information comprises location information associated with the mobile asset.

19. The system of claim 16, wherein the network interface is operable to facilitate communications via one or more of a wide area network, cellular network, or public switch telephone network.

20. The system of claim 16, wherein the content of the promotional information is based at least in part on one or more of a user preference, a time of day, a day of week, a location of the mobile asset, or a movement of the mobile asset.

21. The system of claim 16, wherein the promotional information is formatted as one of an e-mail, a text message or a telephony call.

22. The system of claim 16, wherein the promotional information includes one or more of an audio file, an image, a location identifier, or text.

23. The system of claim 16, wherein the promotional information includes an audio file containing an inaudible tone message.

24. The system of claim 16, wherein the network interface is included in a first device of the system and the at least one processor is included in a second device of the system.

25. A method for presenting promotional information to a mobile asset, the method comprising:
receiving a promotional information request from a mobile asset, wherein the promotional information request is generated by the mobile asset based on the detection of a triggering event;
preparing a promotional information based at least in part on the request received from the mobile asset; and
transmitting the promotional information to a designated asset,
wherein at least one of the prior steps is performed by one or more computers associated with a promotional information server.

26. The method of claim 25, wherein the triggering event comprises at least one of detecting Bluetooth syncing with a predetermined device by the mobile asset, detecting an ignition of a motor vehicle, detecting a move from a predetermined location, detecting a payment event, receiving a near field communications message, or detecting a predetermined movement.

27. The method of claim 25, wherein the mobile asset comprises a mobile phone, a personal digital assistant, or a motor vehicle.

28. The method of claim 25, wherein the promotional information request is received over one or more of a wide area network, cellular network, or public switch telephone network.

29. The method of claim 25, wherein the content of the promotional information is based at least in part on one or more of a user preference, a time of day, a day of week, a location of the mobile asset, or a movement of the mobile asset.

30. The method of claim 25, wherein the promotional information is formatted as one of an e-mail, a text message or a telephony call.

31. The method of claim 25, wherein the promotional information includes one or more of an audio file, an image, a location identifier, or text.

32. The method of claim 30, wherein the promotional information includes an audio file containing an inaudible tone message.

33. The method of claim 30, wherein the promotional information includes an image that is machine readable.

34. The method of claim 25, wherein the mobile asset and the designated asset are the same.
